(19) United States
(12) Patent Application Publication
(10) Pub. No.: US 2023/0202342 A1
(43) Pub. Date: Jun. 29, 2023

(54) CONTROL METHOD OF HYBRID ELECTRIC POWER SUPPLY SYSTEM USED BY ELECTRIC VEHICLE

(71) Applicant: NATIONAL CHUNG SHAN INSTITUTE OF SCIENCE AND TECHNOLOGY, Taoyuan City (TW)

(72) Inventors: PO-LIN SHIH, Taoyuan City (TW); CHI-SHENG WU, Taoyuan City (TW); CHIH-HSIEN CHUNG, Taoyuan City (TW); SHIH-CHANG TSENG, Taoyuan City (TW); GWO-HUEI YOU, Taoyuan City (TW); KUO-KUANG JEN, Taoyuan City (TW)

(21) Appl. No.: 17/564,221

(22) Filed: Dec. 29, 2021

(51) Int. Cl. B60L 58/12; B60L 53/62; G06N 7/02

(52) U.S. Cl. CPC B60L 58/12; B60L 53/62; G06N 7/02; B60W 2510/244

(57) ABSTRACT

A control method of a hybrid electric power supply system used by a hybrid electric vehicle comprises obtaining a gradient of the hybrid electric vehicle, a throttle depth, and a power of an electric device, and calculating a required electric power; obtaining a State Of Charge value of two sets of power sources, and obtaining a power distribution value according to the SOC values and power demand; obtaining real-time output power change values of the two sets of power sources, and using double-level fuzzy energy control to obtain a smooth energy distribution value according to output power changes of the two sets of power sources; and obtaining respective output powers of the two sets of power sources according to the smooth energy distribution value, and controlling a Direct Current converter of the hybrid electric vehicle according to final two sets of output power values.

### BACKGROUND OF THE INVENTION

### 1. Field of the Invention

The present disclosure relates to an electric power supply system used by an electric vehicle, and in particular to a control method of a hybrid electric power supply system and hybrid power double-level fuzzy energy control architecture that is used by an electric vehicle.

### 2. Description of the Related Art

Hybrid power systems have recently become the main trend in energy development, such as fuel cells and lithium battery hybrid systems, lithium battery and supercapacitor hybrid systems, or high-power batteries and high-energy battery hybrid systems. Due to differences in energy characteristics proper proportional control needs to be implemented in order to make energy use more efficient. Take the lithium battery and supercapacitor hybrid system as an example. The super capacitor itself has the characteristics of fast charging and fast discharge. Therefore, the hybrid power system can provide instant high power through the supercapacitor. From this, it can be seen that if the energy distribution control can be performed appropriately, the hybrid power system will have more performance and energy-saving advantages than an independent power system.

Refer to FIG. 1, which is a drawing illustrating a lithium battery and supercapacitor hybrid system architecture of the prior art.

Taking a lithium battery and supercapacitor hybrid power system as shown in FIG. 1, in the traditional hybrid power fuzzy energy management control method, the control parameter is the hybrid power distribution ratio α, which is defined as follows in equation (1):

$$α = \frac{{P}_{bat}}{{P}_{d}} . \qquad ( 1 )$$

Also refer to FIG. 2, which is a drawing illustrating a single-level fuzzy energy control architecture of hybrid power of the prior art.

In equation (1), P_{bat} is the output power of the lithium battery, and P_{d} is the required power. In the traditional single-level fuzzy control method, the general input variables are the required power P_{d} and the residual capacity of the supercapacitor State Of Charge (SOC). According to the consideration of energy management control system and supercapacitor charging and discharging, a single-level fuzzy control architecture can be designed as shown in FIG. 2.

Refer to Table 1 below, which is a table illustrating single-level fuzzy energy control rules for hybrid power of the prior art, and to FIG. 3, which is a graph illustrating hybrid power single-level fuzzy energy control attribution functions.

TABLE 1

| | | | | | | |
|---|---|---|---|---|---|---|
| SOC | α | P_{d} | VL | L | H | VH |

| | | | | |
|---|---|---|---|---|
| VL | VH | H | SH | M |
| L | H | SH | M | SL |
| H | SH | M | SL | L |
| MH | M | SL | L | VL |

When the SOC of the supercapacitor is too low, the power distribution ratio α will output a higher coefficient to allow the lithium battery to charge the supercapacitor while meeting the energy required for the power demand. In addition, when the SOC of the supercapacitor is sufficient to provide energy, it will provide energy for the load in the form of hybrid power. In this fuzzy logic rule, demand power and SOC can be divided into four types: “Very Low” (VL), “Low” (L), “Medium” (H), and “High” (VH) as shown in Table 1. As a result, the attribution function can be designed as shown in FIG. 3.

In this method, although the power distribution ratio α can be controlled, its function is mainly to optimally distribute the output power of the lithium battery and the output power of the supercapacitor. Compared with the mode switching method, the current change will become continuously changing, instead of referring to the mode change to switch the current value to a constant value. Although the energy distribution will be more efficient, the current change may change drastically due to the rapid change of the power distribution ratio α under high frequency calculations. In practice, the power switch may change drastically and cause energy loss. On the other hand, the current that changes too quickly can easily reduce the life of the battery and electronic components.

Thus, it is desirable to have improvements on the conventional hybrid power fuzzy energy control method in order to smooth the output current.

In view of this, an object of the present invention is to add a layer of current filtering function to the original single-layer fuzzy control to smooth current changes.

### BRIEF SUMMARY OF THE INVENTION

An objective of the present disclosure is to provide a control method of a hybrid electric power supply system and hybrid power double-level fuzzy energy control architecture that is used by an electric vehicle.

To achieve at least the above objective, the present disclosure provides a method with an added layer of current filtering function to the single-layer fuzzy control to smooth current changes, increase the life of batteries and electronic components, and improve the economic benefits of electric vehicles.

Due to the limitation of battery characteristics, it is impossible to use a single type of battery in electric vehicles because of driving on various road conditions while meeting the requirements of long life and low cost. Therefore, the use of hybrid power configuration and the use of control technology can make electric vehicles suitable for a variety of road conditions, taking into account the cost and purpose. In the future, it will be extended to all kinds of civilian electric vehicles, including electric buses, electric garbage trucks, etc. After the technology is mature, it can also be applied to the development of military electric vehicles.

In the present invention a second fuzzy current filter is designed in the single-level fuzzy control architecture to obtain the filter parameter β to further smooth the output current.

Among the double-level fuzzy energy control rules for hybrid power, P_{bat} is the output power of the lithium battery, and P_{d} is the required power. The input variables are the required power P_{d} and the residual power SOC of the supercapacitor.

P_{bat_new} and P_{bat_diff} are input variables, where P_{bat_new} is the lithium battery power obtained after the first stage of power distribution, and P_{bat_diff} is the change in the lithium battery power parameters. By substituting the filter parameters obtained by the fuzzy current filter into equation (3):

P_{bat_HFC}=β×P_{bat}+(1−β)×P_{bat_new} (3)

The filtered lithium battery output power P_{bat_HFC} and supercapacitor output power P_{sc_HFC} can be obtained as shown in equations (2) and (3).

P_{bat_diff}=P_{bat_new}−P_{bat} (2)

Properly adjusting the slope of the attribution function can enhance the current smoothing effect, so that a larger β value can be obtained under the same input. After substituting (3) in this way, a more significant current smoothing effect (extended battery life) can be obtained.

The present invention provides a control method of a hybrid electric power supply system used by an electric vehicle, which includes the following steps: obtaining a gradient of the hybrid electric vehicle, a throttle depth, and the power of an electric device, and calculating the required electric power of the hybrid electric vehicle according to the gradient, the throttle depth, and the power of the electric device; obtaining the State Of Charge (SOC) value of the two sets of power sources of the hybrid electric vehicle, and obtaining the power distribution value of the hybrid electric vehicle according to the SOC values of the two sets of power sources and the power demand of the electric device of the hybrid electric vehicle; obtaining the real-time output power change values of the two sets of power sources, and use the double-level fuzzy energy control to obtain the smooth energy distribution value of the hybrid electric vehicle according to the output power changes of the two sets of power sources; and obtaining the respective output powers of the two groups of power sources according to the smooth energy distribution value, and controlling the DC/DC converter of the hybrid electric vehicle according to the final two groups of output power values.

To achieve at least the above objectives, the present disclosure provides a control method of a hybrid electric power supply system and hybrid power double-level fuzzy energy control architecture that is used by an electric vehicle, as exemplified in any one of the above embodiments.

### BRIEF DESCRIPTION OF THE DRAWINGS

FIG. 1 is a schematic diagram illustrating lithium battery and supercapacitor hybrid system architecture of the prior art.

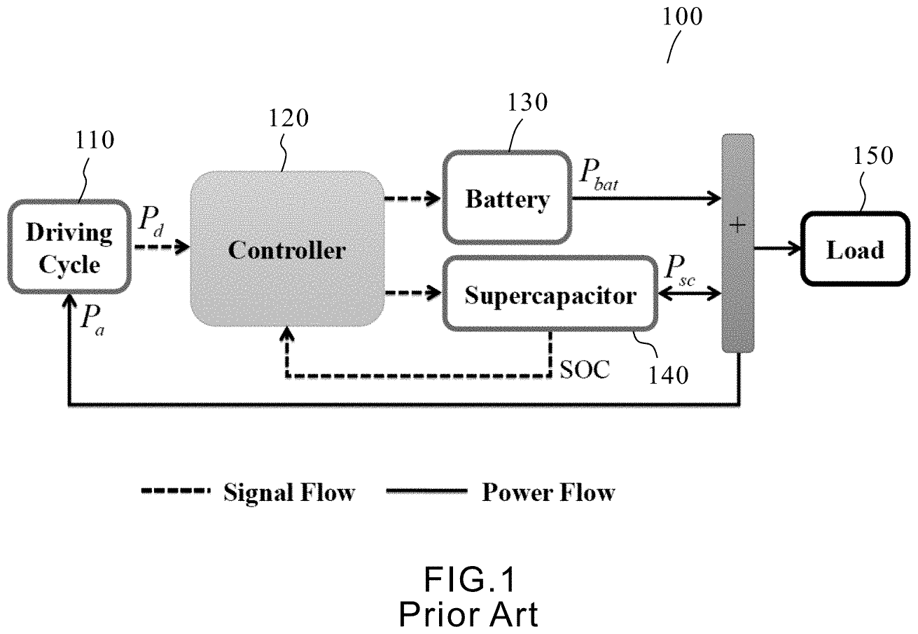

FIG. 2 is a schematic diagram of a single-level fuzzy energy control architecture of the prior art.

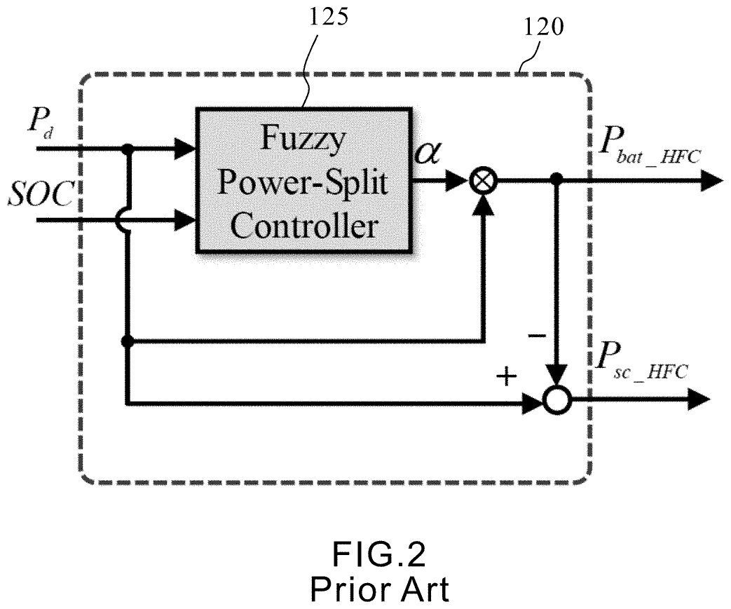

FIG. 3 is a graph illustrating a hybrid power single-level fuzzy energy control attribution functions of the prior art.

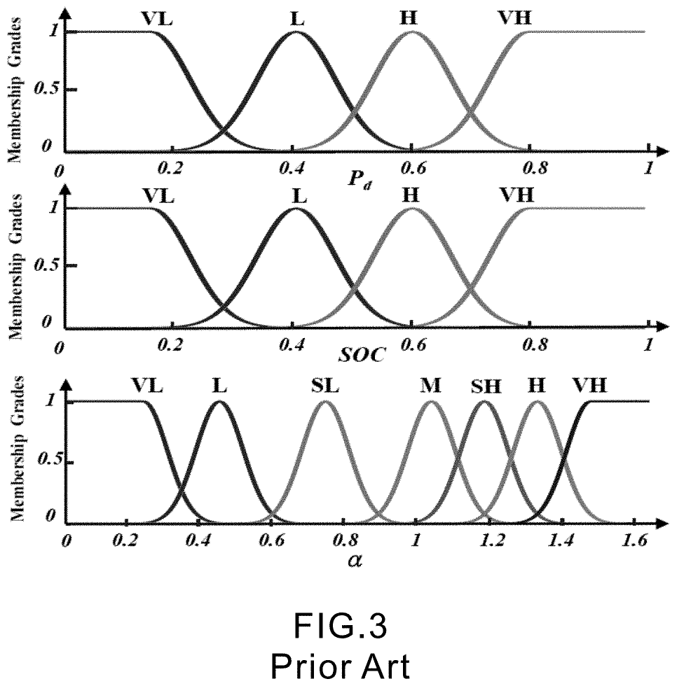

FIG. 4 is a schematic diagram illustrating a hybrid power hardware architecture according to an embodiment of the present invention.

FIG. 5 is a schematic diagram illustrating a hybrid power double-level fuzzy energy control architecture according to an embodiment of the present invention.

FIG. 6 is a graph illustrating hybrid power double-level fuzzy energy control attribution function β according to an embodiment of the present invention.

FIG. 7 is a waveform graph of hybrid energy power distribution results using hybrid power single-level fuzzy energy control.

FIG. 8 is a waveform graph of hybrid energy power distribution results using hybrid power double-level fuzzy energy control according to the present invention.

FIG. 9 is a flowchart illustrating a control method of hybrid electric power supply system according to an embodiment of the present invention.

### DETAILED DESCRIPTION OF THE INVENTION

To facilitate understanding of the object, characteristics and effects of this present disclosure, embodiments together with the attached drawings for the detailed description of the present disclosure are provided.

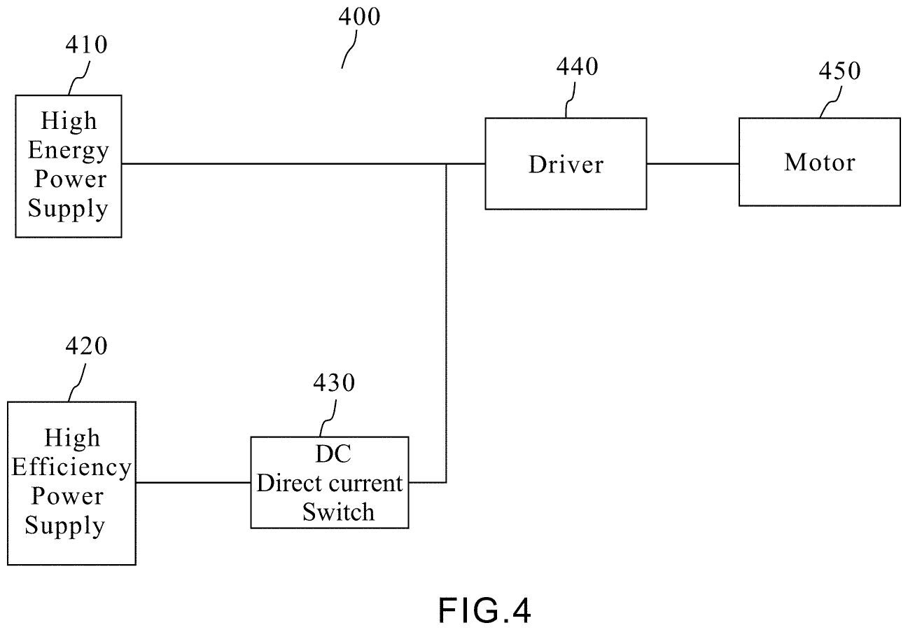

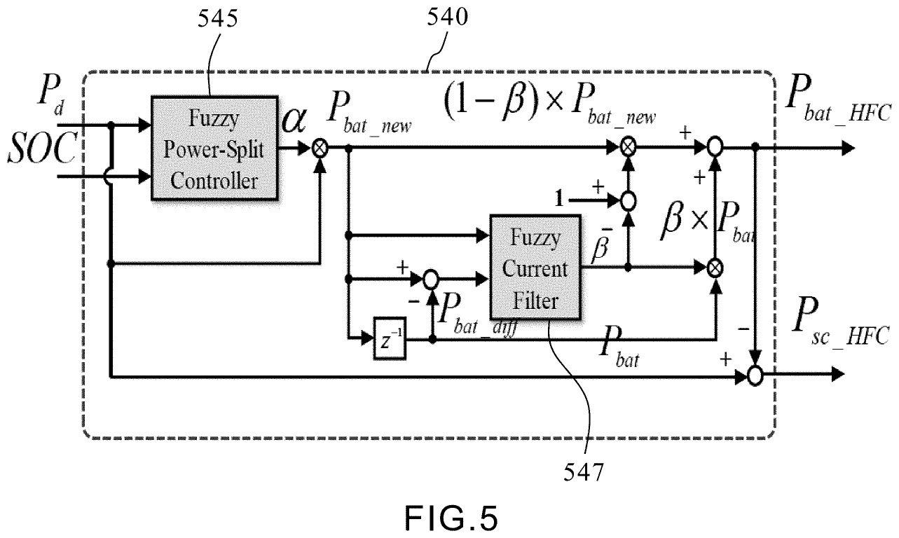

Referring to FIG. 4, which is a schematic diagram illustrating a hybrid power hardware architecture according to an embodiment of the present invention and to FIG. 5, which is a schematic diagram illustrating a hybrid power double-level fuzzy energy control architecture according to an embodiment of the present invention.

As shown in FIG. 4, the hybrid power hardware architecture 400 comprises a high energy power supply 410, a high efficiency power supply 420, a Direct Current (DC) switch 430, a driver 440, and a motor 450.

The high energy power supply 410 is electrically connected to the driver 440. The high efficiency power supply 420 is electrically connected to the DC switch 430, which is electrically connected to the driver 440. The driver 440 is electrically connected to the motor 450 and provides power to drive the motor 450.

As shown in FIG. 5, the hybrid power double-layer fuzzy energy controller 540 comprises a fuzzy power-split controller 545 and a fuzzy current filter 547.

The present invention provides a second fuzzy current filter in the original single-level fuzzy control architecture to obtain the filter parameter β to further smooth the output current. The established fuzzy logic rules are shown in Table 2 below.

TABLE 2

| | | | | | |
|---|---|---|---|---|---|
| P_{bat}_diff | β | P_{bat}_new | S | M | L |

| N/Z/PS | S | | |
|---|---|---|---|
| PM | S | M | M |
| PL | S | M | L |

Among the logic rules, P_{bat} is the output power of the lithium battery, and P_{d} is the required power. The input variables are the required power P_{d} and the residual power SOC of the supercapacitor.

It can be seen from Table 2 that Pbat_new and P_{bat_diff} are input variables, where Pbat_new is the lithium battery power obtained after the first stage of power distribution, and Pbat_diff is the change in the lithium battery power parameters. By substituting the filter parameters obtained by the fuzzy current filter into equation (3) below, the filtered lithium battery output power Pbat_HFC and super capacitor output power Psc_HFC can be obtained as shown in equations (2) and (3) below.

P_{bat_diff}=P_{bat_new}−P_{bat} (2)

P_{bat_HFC}=β×P_{bat}+(1−β)×P_{bat_new} (3)

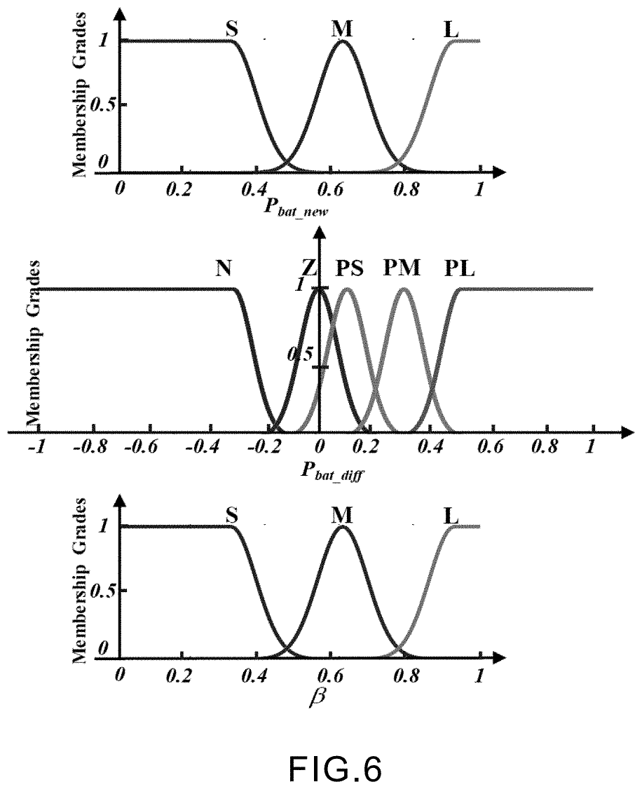

Refer to FIG. 6, which is a graph illustrating hybrid power double-level fuzzy energy control attribution function β according to an embodiment of the present invention as well as continuing to refer to Table 2.

The fuzzy current filter attribution function required by the device can be designed as shown in FIG. 6.

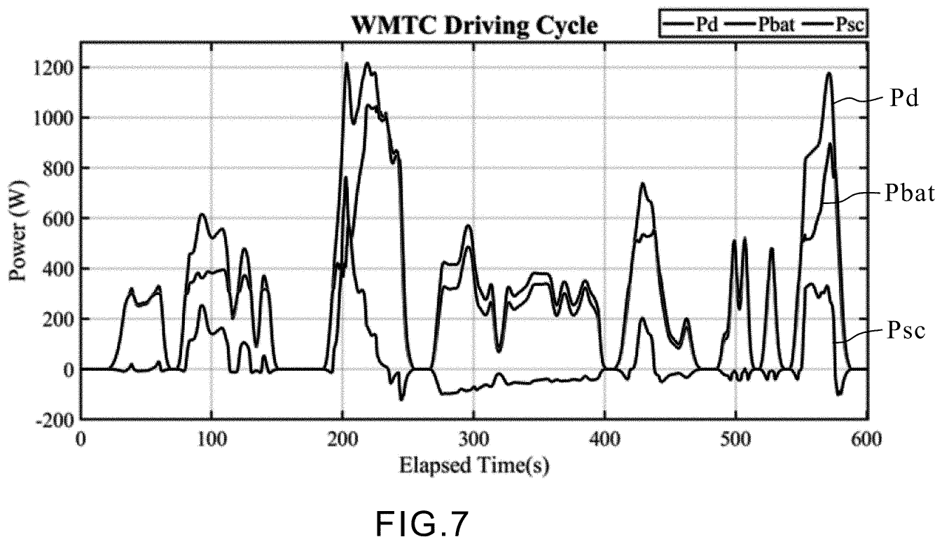

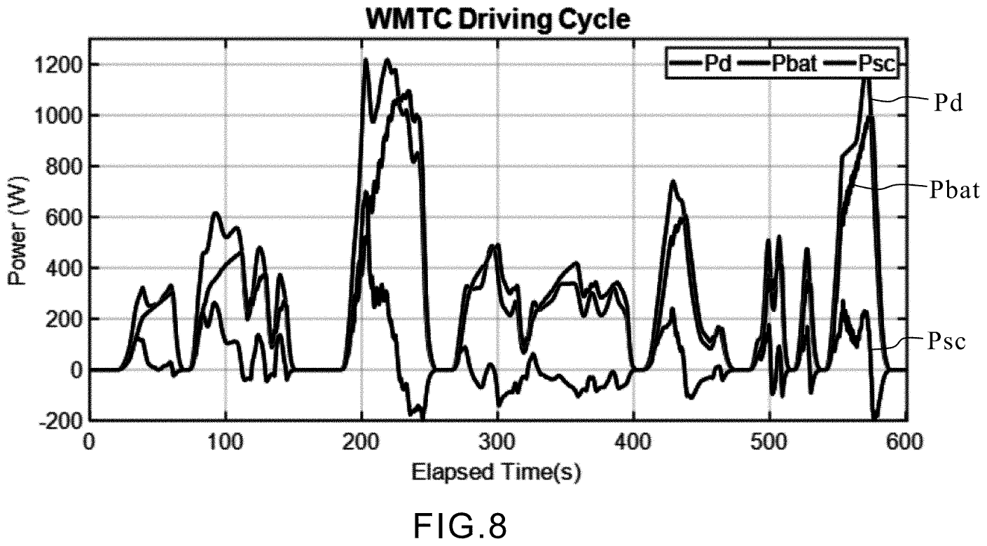

Refer to FIG. 7, which is a waveform graph of hybrid energy power distribution results using hybrid power single-level fuzzy energy control and to FIG. 8, which is a waveform graph of hybrid energy power distribution results using hybrid power double-level fuzzy energy control according to the present invention.

FIG. 7 shows the result of hybrid energy power distribution using hybrid power single-level fuzzy energy control and by properly adjusting the slope of the attribution function in FIG. 6 can enhance the current smoothing effect, so that a larger β value can be obtained under the same input. After substituting equation (3) in this way, a more significant current smoothing effect (extended battery life) can be obtained, as shown in FIG. 8.

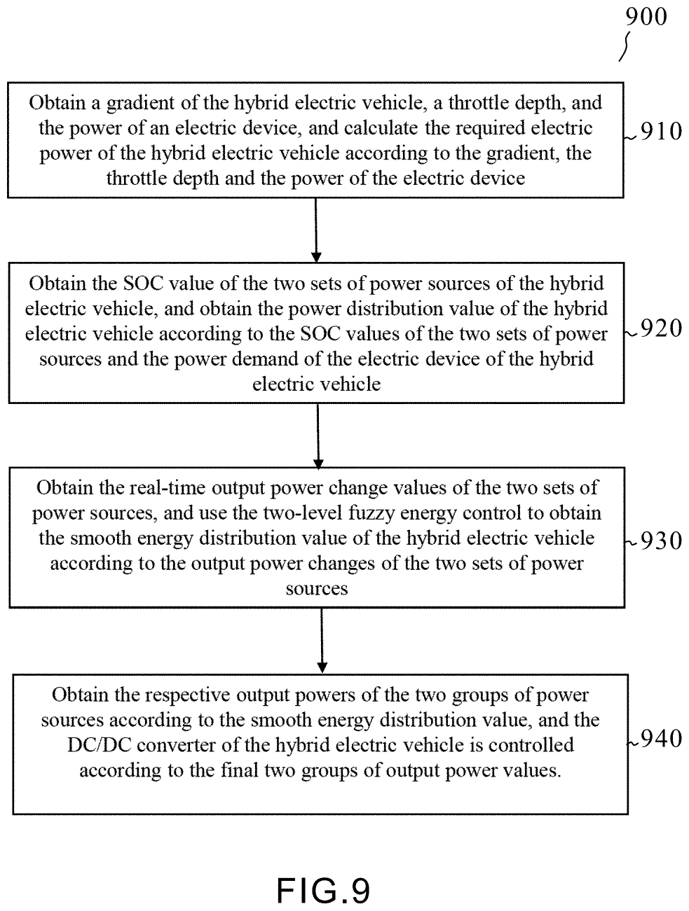

Refer to FIG. 9, which is a flowchart illustrating a control method of hybrid electric power supply system according to an embodiment of the present invention.

The control method 900 of a hybrid electric power supply system used by an electric vehicle includes the following steps: In step 910, obtaining a gradient of the hybrid electric vehicle, a throttle depth, and the power of an electric device, and calculating the required electric power of the hybrid electric vehicle according to the gradient, the throttle depth, and the power of the electric device.

In step 920, obtaining the State Of Charge (SOC) value of the two sets of power sources of the hybrid electric vehicle, and obtaining the power distribution value of the hybrid electric vehicle according to the SOC values of the two sets of power sources and the power demand of the electric device of the hybrid electric vehicle

In step 930, obtaining the real-time output power change values of the two sets of power sources, and use the double-level fuzzy energy control to obtain the smooth energy distribution value of the hybrid electric vehicle according to the output power changes of the two sets of power sources

In step 940 obtaining the respective output powers of the two groups of power sources according to the smooth energy distribution value, and controlling the DC/DC converter of the hybrid electric vehicle according to the final two groups of output power values.

While the present disclosure has been described by means of specific embodiments, numerous modifications and variations could be made thereto by those skilled in the art without departing from the scope and spirit of the present disclosure set forth in the claims.

What is claimed is:

1. A control method of a hybrid electric power supply system used by a hybrid electric vehicle comprising:
obtaining a gradient, a throttle depth, and a power and calculating a required electric power of the hybrid electric vehicle;
obtaining a State Of Charge (SOC) value of a plurality of power sources of the hybrid electric vehicle and obtaining a power distribution value;
obtaining real-time output power change values of the plurality of power sources, and using double-level fuzzy energy control to obtain a smooth energy distribution value; and
obtaining respective output powers of the plurality of power sources according to the smooth energy distribution value, and controlling a Direct Current converter.

2. The control method of a hybrid electric power supply system used by a hybrid electric vehicle according to claim 1, wherein calculating the required electric power of the hybrid electric vehicle is according to the gradient, the throttle depth, and the power of the hybrid electric vehicle.

3. The control method of a hybrid electric power supply system used by a hybrid electric vehicle according to claim 1, wherein obtaining the power distribution value of the hybrid electric vehicle is according to the SOC values of the plurality of power sources and power demand of the hybrid electric vehicle.

4. The control method of a hybrid electric power supply system used by a hybrid electric vehicle according to claim 1, wherein obtaining real-time output power change values of the plurality of power sources, and using double-level fuzzy energy control to obtain the smooth energy distribution value of the hybrid electric vehicle is according to output power changes of the plurality of power sources.

5. The control method of a hybrid electric power supply system used by a hybrid electric vehicle according to claim 1, wherein controlling the Direct Current converter of the hybrid electric vehicle is according to final output power values.

6. The control method of a hybrid electric power supply system used by a hybrid electric vehicle according to claim 1, wherein the double-level fuzzy energy control to obtain a smooth energy distribution value utilizes a fuzzy power-split controller and a fuzzy current filter.

7. A control method of a hybrid electric power supply system used by a hybrid electric vehicle comprising:
obtaining a gradient of the hybrid electric vehicle, a throttle depth, and a power of an electric device, and calculating a required electric power;
obtaining a State Of Charge (SOC) value of two sets of power sources of the hybrid electric vehicle, and obtaining a power distribution value;
obtaining real-time output power change values of the two sets of power sources, and using double-level fuzzy energy control to obtain a smooth energy distribution value; and
obtaining respective output powers of the two sets of power sources according to the smooth energy distribution value, and controlling a Direct Current converter.

8. The control method of a hybrid electric power supply system used by a hybrid electric vehicle according to claim 7, wherein calculating the required electric power of the hybrid electric vehicle is according to the gradient, the throttle depth, and the power of the electric device.

9. The control method of a hybrid electric power supply system used by a hybrid electric vehicle according to claim 7, wherein obtaining the power distribution value of the hybrid electric vehicle is according to the SOC values of the two sets of power sources and power demand of the electric device of the hybrid electric vehicle.

10. The control method of a hybrid electric power supply system used by a hybrid electric vehicle according to claim 7, wherein obtaining real-time output power change values of the two sets of power sources, and using double-level fuzzy energy control to obtain the smooth energy distribution value of the hybrid electric vehicle is according to output power changes of the two sets of power sources.

11. The control method of a hybrid electric power supply system used by a hybrid electric vehicle according to claim 7, wherein controlling the Direct Current converter of the hybrid electric vehicle is according to final two sets of output power values.

12. The control method of a hybrid electric power supply system used by a hybrid electric vehicle according to claim 7, wherein the double-level fuzzy energy control to obtain a smooth energy distribution value utilizes a fuzzy power-split controller and a fuzzy current filter.

13. A control method of a hybrid electric power supply system used by a hybrid electric vehicle comprising:
obtaining a gradient of the hybrid electric vehicle, a throttle depth, and a power of an electric device, and calculating a required electric power of the hybrid electric vehicle according to the gradient, the throttle depth, and the power of the electric device;
obtaining a State Of Charge (SOC) value of two sets of power sources of the hybrid electric vehicle, and obtaining a power distribution value of the hybrid electric vehicle according to the SOC values of the two sets of power sources and power demand of the electric device of the hybrid electric vehicle;
obtaining real-time output power change values of the two sets of power sources, and use double-level fuzzy energy control to obtain a smooth energy distribution value of the hybrid electric vehicle according to output power changes of the two sets of power sources; and
obtaining respective output powers of the two sets of power sources according to the smooth energy distribution value, and controlling a Direct Current converter of the hybrid electric vehicle according to final two sets of output power values.

14. The control method of a hybrid electric power supply system used by a hybrid electric vehicle according to claim 13, wherein the double-level fuzzy energy control to obtain a smooth energy distribution value utilizes a fuzzy power-split controller and a fuzzy current filter.
